(19) United States
(12) Patent Application Publication
(10) Pub. No.: US 2008/0231867 A1
(43) Pub. Date: Sep. 25, 2008

(54) Mechanism for positioning device

(75) Inventor: Yu-Qi Wang, Taipei (TW)

Correspondence Address: BACON & THOMAS, PLLC, 625 SLATERS LANE, FOURTH FLOOR, ALEXANDRIA, VA, 22314-1176, US

(73) Assignee: KYE SYSTEMS CORP., TAIPEI (TW)

(21) Appl. No.: 11/790,716

(22) Filed: Apr. 27, 2007

(30) Foreign Application Priority Data
Mar. 23, 2007 (TW) 096110097

(51) Int. Cl. G01B 11/00

(52) U.S. Cl. 356/622

(57) ABSTRACT

The present invention relates to a positioning device, and in particular to a mechanism using an image detecting module. The present invention comprises a base having an image detecting module, a control circuit, and a driving module therein. The base has a rotateable plate on the base for carrying an object. The base further has a light pervious area for receiving a light beam coming from a remote control. A convex reflector is located within the base to reflect the image to the image detecting module.

### BACKGROUND OF THE INVENTION

1. Field of the Invention

The present invention relates to a wireless positioning device, and particularly to a wireless image-detecting positioning device that can adjust the position of an object to directly face a target based on an image image detected by the positioning device.

2. Description of the Prior Art

A wireless-control positioning device carries an object, for example a still camera, a web cam, or a video camera, such that a user can use a remote controller (which generally emits an infrared ray) to cause the object to face the user, or another desired target, based on the user's observation of the object's orientation relative to the desired target, through the user's own eyes. Because positioning conventionally involves a stepped adjustment, however, it is difficult to cause the object to face the target exactly. Even a small angle inaccuracy will cause the target to be out of the field of view of the cam or camera.

U.S. Pat. No. 6,466,742 discloses a light detecting system which can sense a light signal emitted from the remote controller, and the camera can focus on the desired target or user, according to the determination of an extra camera sensor, without the need for naked eye observation of camera orientation relative to the target. However, the cited patent does not disclose how to retrieve the light signal precisely, and the system disclosed therein is subject to the accuracy at which the user points the remote controller at the object.

### SUMMARY OF THE INVENTION

It is an object of the present invention to provide a mechanism for a positioning device that solves at least the above-described disadvantages of the prior art.

It is another object of the present invention to provide a wide range operating mechanism for a positioning device.

To accomplish the objects mentioned above, the invention preferably includes a base having an image detecting module, a control circuit, and a driving module therein. The base has a rotateable plate for carrying an object. The base further has a light pervious area for receiving a light beam generated by a remote control. A convex reflector is located within the base at a position corresponding to the position of the image detecting module so as to direct light thereto.

### BRIEF DESCRIPTION OF THE DRAWINGS

FIG.1 is a perspective view of the present invention.

FIG. 2 is a sectional view of FIG. 1.

FIG. 3 is a top view of FIG. 2.

FIG. 4 is block diagram showing the control circuit.

FIG. 5 is another sectional view of FIG. 1 showing a light beam penetrating the base of the invention.

FIG. 6 is a top view of FIG. 5 showing the trace of the light beam.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims. The so-called object may include a camera, web cam, game controller . . . or any other object that needs to be aimed, and that may be used with the positioning device of the invention.

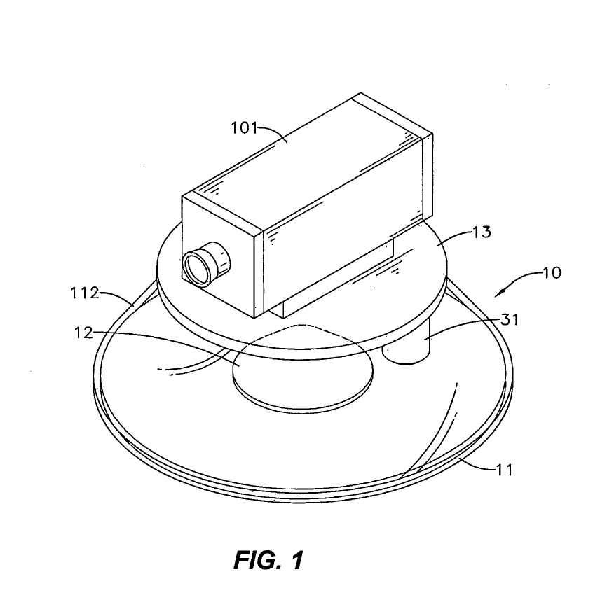

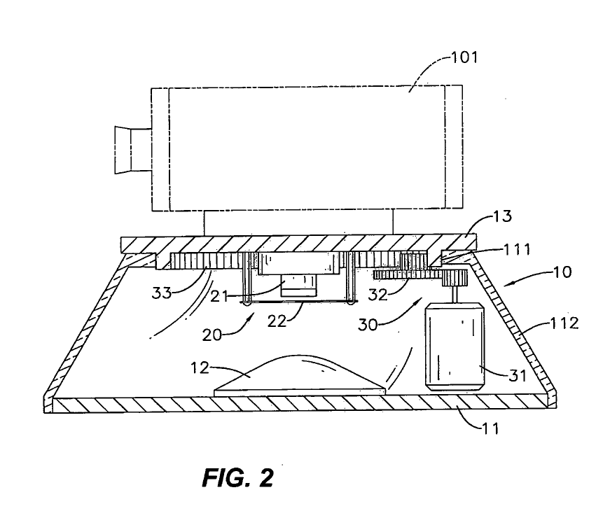

Referring to FIGS. 1 and 2, the present invention comprises a base 10 for receiving a light beam coming from a remote control. The base 10 also has an opening 111 for accommodating a rotatable plate 13 on top. The light pervious area 112 is located around the periphery of the base 10. The light beam can be a visible or invisible light beam, and the light pervious area 112 allows the light beam to penetrate the base. A convex reflector 12 is located within the base 10 for reflecting the light beam. The plate 13 can carry an object, such as a camera 101, on the top of the plate 13. An image detecting module 20 is positioned on the top of the reflector 12 such that the reflected light beam can be detected by the detecting module 20. The image detecting module 20 has an image detector 21 and a filter 22. The filter 22 allows the reflected light beam to be detected in a specific light spectrum.

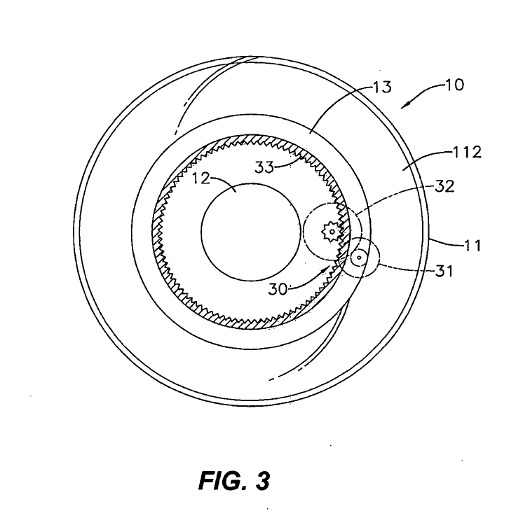

Referring to FIGS. 1 and 3, a driving module 30 couples to a side of the plate 13 such that the driving module 30 can rotate the plate 13 to a desired direction where the remote control emits the light beam. The driving module 30 has a motor 31, gears 32, and gearwheel 33. The motor 31 rotates the gears 32 and then gearwheel 33 such that the plate 13 can be rotated to the desired direction.

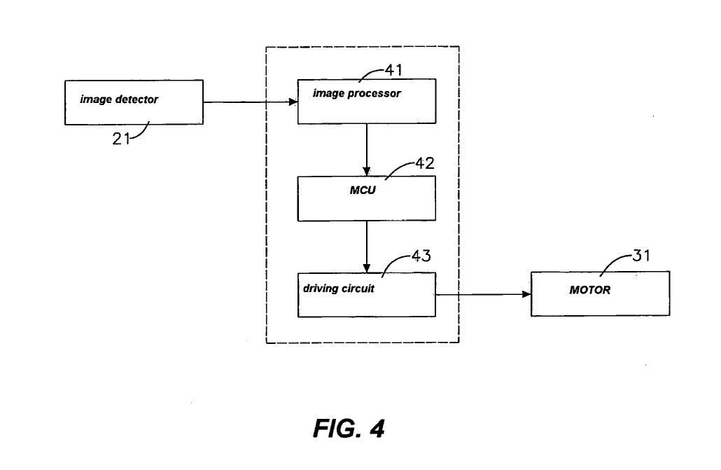

Referring to FIG. 4, a control circuit (not shown) is coupled to the driving module 30 and the image detecting module 20. The driving module 30 may include an image processor 41, a micro control unit (MCU) 42 and a driving circuit 43. The processor 41 will constantly analyze a stored blank image focused on the convex reflector 12, and further compare with the stored blank image with a newly captured image having a light spot P which is formed by the light beam coming from the remote control. The processor 41 further determines the direction of the spot on the convex reflector 12, and generates a signal to the MCU 42. The MCU 42 sends a control signal to the driving circuit 43, and the driving circuit 43 drives the driving module 30 and forces the plate 13 to turn to a desired position.

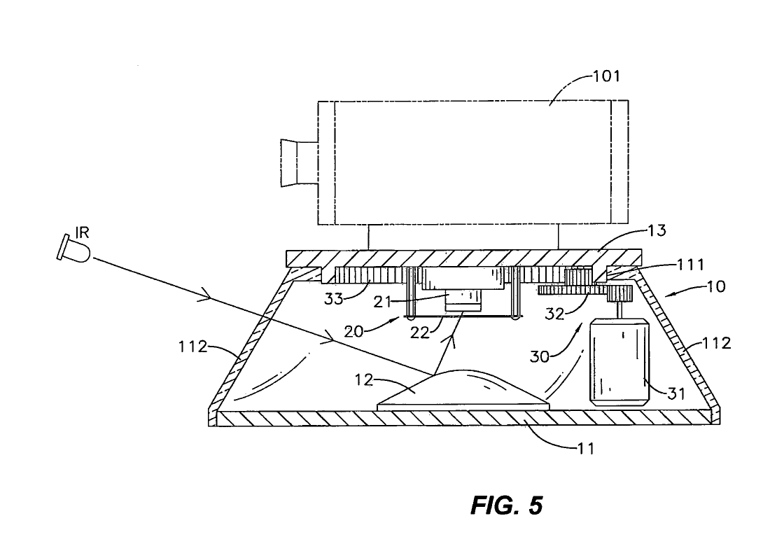

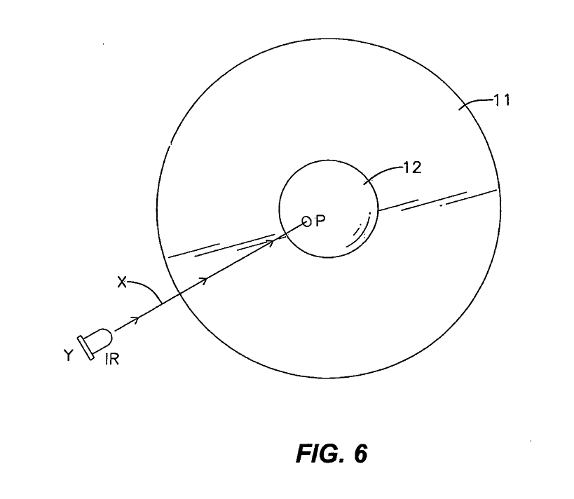

Referring to FIGS. 5 and 6, once the remote control at Y emits a light beam along the trace X and toward the base 10. The light beam penetrates the light pervious area 112 and forms a light spot P on the convex reflector 12. The image detector 21 captures a new image with the light spot P, and the image processor 41 determines the direction of the spot P and send a signal to the MCU 42. MCU 42 controls the driving circuit 43 and the driving module 30, such that the plate 13 is turned to the desired position corresponding to the remote control at Y.

Referring to FIGS. 1 and 2, once the user causes light to be emitted from the remote control to the base 112, then the convex reflector 12 receives the light beam, and the driving module 30 will force the camera 101 or any image capturing device toward the location of the user. The benefit of the convex reflector 12 is that the light beam generated from the remote control can be emitted from almost any angle position relating to the base 112. In other words, the base 10 can be operated in the widest range such that the user doesn't have to aim at the base 10 or the camera 101 very precisely.

It is appreciated that the traditional infrared ray control method (i.e. step-by-step control) can be adopted for use with the present invention.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A mechanism for an object positioning device, comprising:
a base having a light pervious area;
a reflector located within the base on which the object is mounted;
a plate at the top of the base;
an image detecting module;
a driving module;
a control circuit;
wherein a light beam penetrates the light pervious area and forms a spot on the reflector; the image detecting module detects the direction of the spot relating to the base; the control circuit commands the driving module to move the plate toward the direction of the spot.

2. The mechanism for a positioning device as claimed in claim 1, wherein the control circuit includes an image processor, a micro control unit and a driving circuit, the image processor capturing the image of the spot on the reflector and comparing the captured image with a blank image to determine a position of the object.

3. The mechanism for a positioning device as claimed in claim 1, wherein the reflector is a convex reflector.

4. The mechanism for a positioning device as claimed in claim 3 wherein the image detecting module is on a top of the convex reflector.

5. The mechanism for a positioning device as claimed in claim 4 wherein the image detecting module further has a filter.

6. The mechanism for a positioning device as claimed in claim 1, wherein the light beam is coming from a remote control.

7. A image capturing device having a base, comprising:
an image detecting module, a control circuit, and a driving module;
the base having a rotatable plate on the base for carrying the image capturing device;
wherein the base has a light pervious area for receiving a light beam generated by a remote control; and
wherein a reflector is located within the base at a position enabling reflection of the image to the image detecting module.
